(19) United States
(12) Patent Application Publication
(10) Pub. No.: US 2025/0041791 A1
(43) Pub. Date: Feb. 6, 2025

(54) Gas Separation Device

(71) Applicant: SEIKO EPSON CORPORATION, Tokyo (JP)

(72) Inventor: Masahiro FURUSAWA, Chino (JP)

(21) Appl. No.: 18/788,320

(22) Filed: Jul. 30, 2024

(30) Foreign Application Priority Data
Jul. 31, 2023 (JP) 2023-124511

(51) Int. Cl. B01D 53/22; B01D 63/08

(52) U.S. Cl. CPC B01D 53/226; B01D 63/082; B01D 2313/105; B01D 2319/04

(57) ABSTRACT

A gas separation device includes a first separation membrane unit including a first gas separation membrane configured to separate a predetermined gas component contained in a mixed gas supplied to a first front surface, by allowing the predetermined gas component to permeate through a first back surface, which is opposite to the first front surface, and a first gas flow path section through which the separated predetermined gas component flows; a gas introduction unit that is arranged via a gap from the first front surface and that includes a gas introduction section that introduces the mixed gas toward the first gas separation membrane; and a gas exhaust unit that is arranged via a gap from the first front surface and that includes a gas exhaust section that exhausts the mixed gas introduced from the gas introduction unit.

The present application is based on, and claims priority from JP Application Serial Number 2023-124511, filed Jul. 31, 2023, the disclosure of which is hereby incorporated by reference herein in its entirety.

### BACKGROUND

### 1. Technical Field

The present disclosure relates to a gas separation device.

### 2. Related Art

In order to achieve carbon neutral or carbon negative, a technology for capturing and recovering carbon dioxide exhausted from thermal power plants or boiler equipment, or the like or carbon dioxide in the atmosphere has been studied. As this technique, a membrane separation method for separating carbon dioxide using a gas separation membrane is known.

For example, JP-A-2023-033590 discloses a gas separation method using a gas separation membrane to selectively permeate through a specific gas (A) from a mixed gas. The gas separation method includes supplying the mixed gas to one surface of the gas separation membrane, wherein the membrane thickness of the gas separation membrane is 1 μm or less, the concentration of the gas (A) in the mixed gas is 10,000 ppm by mass or less, and the selective permeation of the gas (A) by the gas separation membrane is performed under the condition that the pressure difference between both surfaces of the gas separation membrane is 1 atm or less.

According to such a gas separation method, the gas (A) can be favorably separated even under a mild condition in which the pressure difference between both surfaces of the gas separation membrane is 1 atm or less.

In a membrane separation method, a problem is to increase the separation efficiency of a predetermined gas component. In order to increase the separation efficiency of the gas separation membrane, it is necessary to maintain a high concentration of a predetermined gas component upstream of the gas separation membrane. However, when a predetermined gas component permeates through the gas separation membrane, the concentration of the gas component on an upstream side decreases accordingly, resulting in a decrease in separation efficiency.

Therefore, there is a need to realize a gas separation device in which the concentration of a predetermined gas component hardly decreases even when the predetermined gas component permeates through a gas separation membrane, and the decrease in separation efficiency is suppressed.

### SUMMARY

A gas separation device according to an application example of the present disclosure includes a first separation membrane unit including a first gas separation membrane configured to separate a predetermined gas component contained in a mixed gas supplied to a first front surface, by allowing the predetermined gas component to permeate through a first back surface, which is opposite to the first front surface, and a first gas flow path section through which the separated predetermined gas component flows; a gas introduction unit that is arranged via a gap from the first front surface and that includes a gas introduction section that introduces the mixed gas toward the first gas separation membrane; and a gas exhaust unit that is arranged via a gap from the first front surface and that includes a gas exhaust section that exhausts the mixed gas introduced from the gas introduction unit.

### BRIEF DESCRIPTION OF THE DRAWINGS

FIG. 1 is a cross-sectional view showing a configuration of a gas separation device according to a first embodiment.

FIG. 2 is an exploded perspective view of the gas separation device shown in FIG. 1.

FIG. 3 is a graph showing the relationship between the gas permeability of carbon dioxide of a first gas separation membrane and the concentration of carbon dioxide at a first front surface of the first gas separation membrane.

FIG. 4 is a cross-sectional view showing a configuration of a gas separation device according to a second embodiment.

FIG. 5 is a perspective view of the gas separation device shown in FIG. 4.

### DESCRIPTION OF EMBODIMENTS

Hereinafter, a gas separation device of the present disclosure will be described in detail based on an embodiment shown in the accompanying drawings.

### 1. First Embodiment

First, a gas separation device according to a first embodiment will be described.

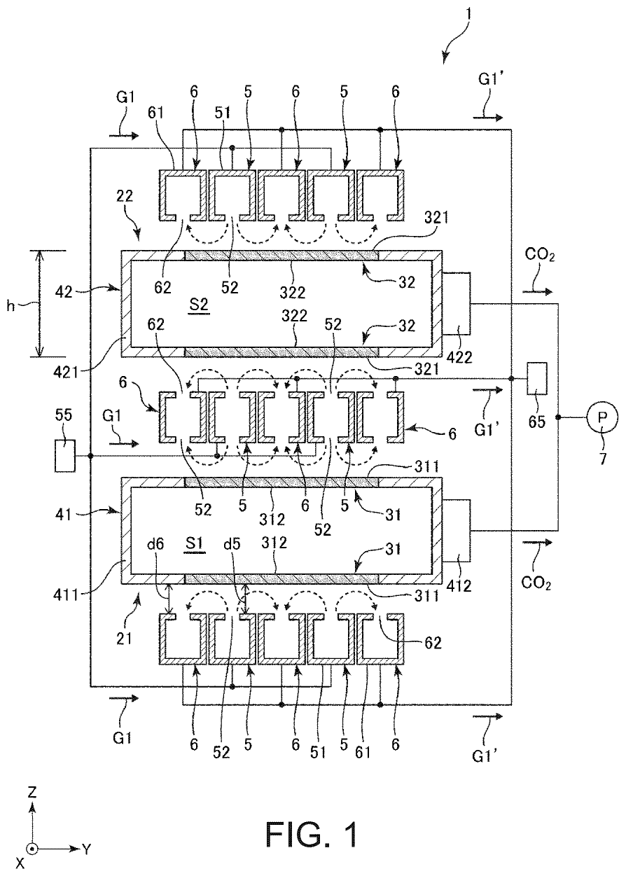

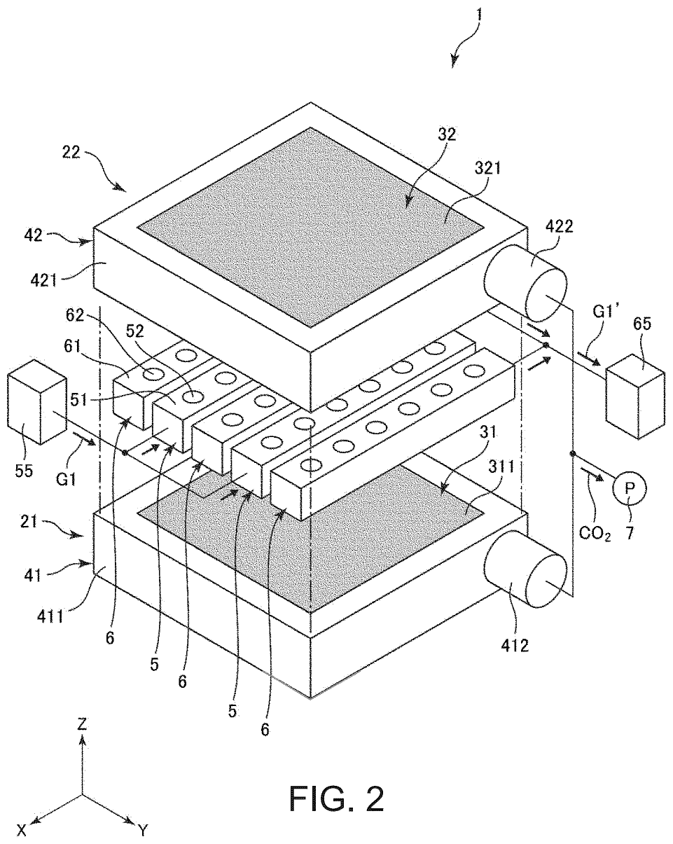

FIG. 1 is a cross-sectional view showing a configuration of a gas separation device 1 according to the first embodiment. FIG. 2 is an exploded perspective view of the gas separation device 1 shown in FIG. 1. In FIG. 2, a part of the configuration shown in FIG. 1 is omitted.

In each drawing of the present application, an X-axis, a Y-axis, and a Z-axis are set as three axes orthogonal to each other. Each axis is represented by an arrow, and a tip end side of the arrow is “plus” and a base end side of the arrow is “minus”. In the following description, for example, an “X-axis direction” includes both a plus direction and a minus direction of the X-axis. The same applies to a Y-axis direction and a Z-axis direction. In the following description, in particular, a Z-axis plus side is also referred to as “upper”, and a Z-axis minus side is also referred to as “lower”. However, the Z-axis does not need to be parallel to the vertical axis, and may intersect the vertical axis.

### 1.1. Outline

The gas separation device 1 shown in FIG. 1 includes a first separation membrane unit 21, a second separation membrane unit 22, a gas introduction unit 5, a gas exhaust unit 6, and an exhaust pump 7. The first separation membrane unit 21 includes a first gas separation membrane 31, and the second separation membrane unit 22 includes a second gas separation membrane 32. The gas introduction unit 5 introduces a mixed gas G1 toward a first front surface 311 of the first gas separation membrane 31 and a second front surface 321 of the second gas separation membrane 32, and the gas exhaust unit 6 exhausts the mixed gas G1 introduced toward the first front surface 311 and the second front surface 321.

In such a gas separation device 1, after the mixed gas G1 is introduced from the gas introduction unit 5 toward the first front surface 311 and second front surface 321, the mixed gas G1 can be quickly exhausted by the gas exhaust unit 6. In the vicinity of the first front surface 311 and the second front surface 321, since the separation of carbon dioxide CO₂ progresses immediately after the introduction of the mixed gas G1, the concentration of the carbon dioxide CO₂ decreases as time elapses, and the separation efficiency decreases. The gas exhaust unit 6 quickly exhausts the mixed gas G1 in which the concentration of carbon dioxide CO₂ is reduced in this way, thereby suppressing the mixed gas G1 in which the concentration of carbon dioxide CO₂ is reduced from remaining in the vicinity of the first front surface 311 and the second front surface 321. As a result, the concentration of carbon dioxide CO₂ at the first front surface 311 and the second front surface 321 can be maintained high, and a decrease in the separation efficiency in the first gas separation membrane 31 and the second gas separation membrane 32 can be suppressed.

The mixed gas G1 contains carbon dioxide CO₂, which is a separation target gas component, and other gas components (non-target components). The mixed gas G1 is not particularly limited, but is, for example, atmosphere, exhaust gas exhausted from a facility such as a factory, or the like. The separation target gas component is not limited to carbon dioxide CO₂, but may be other gas components. The non-target component varies depending on the mixed gas G1, but when the mixed gas G1 is the atmosphere, it is nitrogen, oxygen, or the like.

### 1.2. Separation Membrane Unit

In the gas separation device 1 shown in FIG. 1, the first separation membrane unit 21 and the second separation membrane unit 22 are arranged so as to be separated from each other in the Z-axis direction. When the gas separation device 1 includes a plurality of separation membrane units, it is possible to realize a gas separation device 1 having particularly high separation efficiency of carbon dioxide CO₂. The number of separation membrane units provided in the gas separation device 1 may be one or three or more.

The first separation membrane unit 21 includes two first gas separation membranes 31, 31 and a first gas flow path section 41. The first gas separation membrane 31 separates carbon dioxide CO₂ from the mixed gas G1 by permeation. The first gas flow path section 41 includes an internal space S1. The internal space S1 is exhausted by the exhaust pump 7. Thus, the first gas flow path section 41 exhausts and recovers gas containing carbon dioxide CO₂ (gas having a higher concentration of carbon dioxide CO₂ than that of the mixed gas G1) that has permeated and been separated into the internal space S1.

The second separation membrane unit 22 includes two second gas separation membranes 32, 32 and a second gas flow path section 42. The second gas separation membrane 32 separates the carbon dioxide CO₂ from the mixed gas G1 by permeation. The second gas flow path section 42 includes an internal space S2. The internal space S2 is also exhausted by the exhaust pump 7. Thus, the second gas flow path section 42 exhausts and recovers gas containing carbon dioxide CO₂ (gas having a higher concentration of carbon dioxide CO₂ than that of the mixed gas G1) that has permeated and been separated into the internal space S2.

### 1.2.1. Gas Separation Membrane

The first gas separation membrane 31 includes the first front surface 311 and the first back surface 312 which are opposite to each other. The second gas separation membrane 32 includes the second front surface 321 and the second back surface 322 which are opposite to each other. The first gas separation membrane 31 and the second gas separation membrane 32 may have the same configuration or different configurations. Hereinafter, the first gas separation membrane 31 will be described as a representative, but the following description is also applied to the second gas separation membrane 32.

The first gas separation membrane 31 allows carbon dioxide CO₂ contained in the mixed gas G1 supplied to a first front surface 311 side to permeate to a first back surface 312 side selectively or preferentially to other gas components. Therefore, the first gas separation membrane 31 has a property that the gas permeability of carbon dioxide CO₂ is higher than the gas permeability of non-target components (a property that the gas selection ratio of carbon dioxide CO₂ is high). Hereinafter, the ratio of the gas permeability of carbon dioxide to the gas permeability of nitrogen is simply referred to as “gas selection ratio”.

The gas selection ratio of the first gas separation membrane 31 is desirably 3 or more, and more desirably 10 or more and 1000 or less. When the gas selection ratio is within the above range, the first gas separation membrane 31 can efficiently separate and recover carbon dioxide CO₂ from the mixed gas G1.

The gas permeability of nitrogen of the first gas separation membrane 31 and the gas permeability of carbon dioxide of the first gas separation membrane 31 are each measured according to a gas permeability test method (Part 1: differential pressure method) defined in JIS K 7126-1:2006. A gas permeability measuring device is used for the measurement. Examples of a gas permeability measuring device include GTR-11A/31A manufactured by GTR TEC Corporation. In this device, gas that has permeated through the first gas separation membrane 31 is introduced into a gas chromatograph, and the gas permeability of each component is measured.

In the first gas separation membrane 31, the gas permeability of carbon dioxide is desirably 1000 GPU or more, more desirably 5000 GPU or more and 100000 GPU or less, and even more desirably 10000 GPU or more and 50000 GPU or less. Thus, it is possible to realize the first gas separation membrane 31 capable of reducing the input amount of energy required for separation, specifically, capable of reducing the pressure difference between a first front surface 311 side and a first back surface 312 side. When the gas permeability of carbon dioxide of the first gas separation membrane 31 is less than the lower limit value, a large amount of energy is required for the separation of carbon dioxide, and there is a possibility that the economic efficiency in an operation of the gas separation device 1 is reduced. On the other hand, when the gas permeability of carbon dioxide of the first gas separation membrane 31 exceeds the upper limit value, there is a possibility that the cost for manufacturing the first gas separation membrane 31 may increase. Here, 1 GPU is 3.35×10⁻¹⁰ mol·m⁻²·s⁻¹·Pa⁻¹.

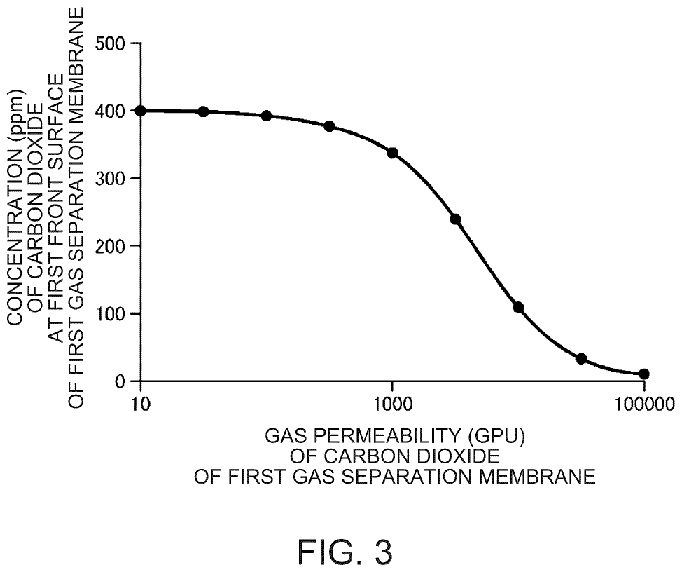

FIG. 3 is a graph showing the relationship between the gas permeability of carbon dioxide of the first gas separation membrane 31 and the concentration of carbon dioxide at the first front surface 311 of the first gas separation membrane 31. The graph shown in FIG. 3 plots the concentration of carbon dioxide at the first front surface 311 one second after the mixed gas G1 is supplied and when the flow speed of the mixed gas G1 having a carbon dioxide concentration of 400 ppm supplied onto the first front surface 311 is zero. In this case, since the flow speed is zero, it is assumed that carbon dioxide spreads in the mixed gas G1 only by the effect of diffusion. Further, the gas selection ratio of the first gas separation membrane 31 is assumed to be infinity.

As is clear from FIG. 3, the concentration of carbon dioxide rapidly decreases when the gas permeability of carbon dioxide of the first gas separation membrane 31 is 1000 GPU or more. Therefore, when the gas permeability is 1000 GPU or more, the concentration of carbon dioxide on the first front surface 311 is particularly important for enhancing the separation efficiency of carbon dioxide in the first gas separation membrane 31.

The thickness of the first gas separation membrane 31 is not particularly limited, but is desirably 1 nm or more and 1000 μm or less, more desirably 5 nm or more and 100 μm or less, and even more desirably 10 nm or more and 10 μm or less.

The average thickness of the first gas separation membrane 31 is an average value of the thicknesses measured at 10 locations of the first gas separation membrane 31. For example, a thickness gauge can be used to measure the thickness of the first gas separation membrane 31.

The size of the first gas separation membrane 31 is not particularly limited, but the maximum length is desirably 5 cm or more and 2 m or less, and more desirably 10 cm or more and 1 m or less. Thereby, the first gas separation membrane 31 having mechanical strength enough to withstand the atmospheric pressure difference and capable of securing a sufficient gas permeation amount is obtained.

The first gas separation membrane 31 may be a single layer or a composite layer formed by laminating a plurality of layers. The first gas separation membrane 31 may be supported by a porous layer that is porous. In particular, when the thickness of the first gas separation membrane 31 is 100 μm or less, it is desirable to laminate the first gas separation membrane 31 and a porous layer to improve the overall strength.

Examples of the constituent material of the first gas separation membrane 31 include a polymer material, a ceramic material, a metal material, and the like. The constituent material of the first gas separation membrane 31 may be a composite material of these materials or a composite material of these materials and another material.

Examples of the polymer material include polyethylene, polyolefin resins such as polypropylene, polytetrafluoroethylene, polyvinyl fluoride, fluorine-containing resins such as polyvinylidene fluoride, organopolysiloxane (silicone Resin), polystyrene, cellulose, cellulose acetate, polyurethane, polyacrylonitrile, polyphenylene oxide, polysulfone, polyether sulfone, polyimide, polyaramid, nylon, and the like.

Examples of the ceramic material include alumina, cordierite, mullite, silicon carbide, and zirconia. Examples of the metal material include stainless steel and the like.

### 1.2.2. Gas Flow Path Section

The first gas flow path section 41 includes a wall body 411 defining the internal space S1 through which gas containing the separated carbon dioxide CO₂ flows, and an exhaust port 412 provided in the wall body 411. The second gas flow path section 42 includes a wall body 421 defining the internal space S2 through which gas containing the separated carbon dioxide CO₂ flows, and an exhaust port 422 provided in the wall body 421. The first gas flow path section 41 and the second gas flow path section 42 may have the same configuration or different configurations. Hereinafter, the first gas flow path section 41 will be described as a representative, but the following description is also applied to the second gas flow path section 42.

The wall body 411 is a box body that has a flat shape extending along an X-Y plane, is hollow, and has a substantially rectangular parallelepiped shape. The internal space S1 described above is defined by the wall body 411. A part of each of two surfaces intersecting with the Z-axis has an open section, and the first gas separation membrane 31 is arranged so as to close the open section. Therefore, as shown in FIG. 1, two first gas separation membranes 31, 31 arranged one above the other are arranged in the wall body 411. That is, the two first gas separation membranes 31, 31 are arranged such that the first back surfaces 312 of each face each other. This makes it possible to separate carbon dioxide CO2 on both an upper surface side and a lower surface side of the first separation membrane unit 21. The number of first gas separation membranes 31 provided on a single wall body 411 is not particularly limited, and may be one, or three or more. In the present embodiment, the first gas separation membrane 31 is arranged so as to intersect with the Z-axis, but a first gas separation membrane 31 may be added that is arranged so as to intersect with the X-axis.

The exhaust port 412 has a tubular shape and communicates with the internal space S1. As shown in FIG. 1, the exhaust pump 7 is connected to the exhaust port 412. The internal space S1 is exhausted through the exhaust port 412 by the operation of the exhaust pump 7. The pressure of the internal space S1 when the exhaust pump 7 is operating may be less than the atmospheric pressure, and is desirably 10 kPa or less, and more desirably 1 kPa or less. Thus, an adequate atmospheric pressure difference can be secured between a first front surface 311 side and a first back surface 312 side of the first gas separation membrane 31, and the separation efficiency of carbon dioxide CO2 can be sufficiently enhanced. The lower limit value of the pressure in the internal space S1 is not particularly limited, but is desirably 0.001 Pa or more and more desirably 0.1 Pa or more in consideration of the introduction cost and the running cost of the exhaust pump 7, the deformation resistance of the first gas separation membrane 31, and the like. Based on these viewpoints, the atmospheric pressure difference between the internal space S1 and the outside is desirably 0.001 Pa or more and 10 kPa or less, more desirably 0.1 Pa or more and 1 kPa or less.

Examples of the constituent materials of the wall body 411 and the exhaust port 412 include a resin material, a metal material, and a ceramic material, and the like. It may also be a composite material containing these materials.

The wall body 411 and the first gas separation membrane 31 are coupled so as not to impair the airtightness. The coupling method is not particularly limited, and examples thereof include coupling by an adhesive, coupling by sandwiching or the like, and coupling by fusing or the like.

The height h of the wall body 411 in the Z-axis direction is not particularly limited, but is desirably 5 mm or more and 30 cm or less, and more desirably 1 cm or more and 10 cm or less. This makes it possible to avoid an increase in the size of the gas separation device 1.

The maximum length of the wall body 411 along the X-Y plane is not particularly limited, but is desirably 5 cm or more and 2 m or less, and more desirably 10 cm or more and 1 m or less. Thus, the first gas separation membrane 31 having a sufficient size can be arranged, and the first separation membrane unit 21 capable of securing a sufficient gas permeation amount can be realized.

### 1.3. Gas Introduction Unit

The gas introduction unit 5 includes first mixed gas flow path sections 51, first opening sections 52 (gas introduction section), and a gas introduction pump 55.

The first mixed gas flow path sections 51 are arranged at positions adjacent to the first separation membrane unit 21 and the second separation membrane unit 22 in the Z-axis direction. Specifically, the gas introduction units 5 are arranged below the first separation membrane unit 21, above the second separation membrane unit 22, and between the first separation membrane unit 21 and the second separation membrane unit 22.

As shown in FIG. 2, the first mixed gas flow path sections 51 have a prismatic shape elongated in the X-axis direction and have a hollow interior. The first mixed gas flow path sections 51 are connected to the gas introduction pump 55 via pipes. The mixed gas G1 sent from the gas introduction pump 55 fills the first mixed gas flow path sections 51. In the first mixed gas flow path sections 51, a part of a surface facing the first front surface 311 of the first gas separation membrane 31 and the second front surface 321 of the second gas separation membrane 32 is open. These are the first opening sections 52, and the mixed gas G1 supplied to the first mixed gas flow path sections 51 is introduced from the first opening sections 52 toward the first front surface 311 and second front surface 321. In FIG. 1, the flow of the mixed gas G1 is indicated by broken line arrows.

The gas introduction unit 5 desirably includes a plurality of first opening sections 52. By this, the mixed gas G1 can be uniformly introduced into a wide range, and the separation efficiency can be easily increased.

The mixed gas G1 is introduced into the first mixed gas flow path section 51 configured as described above from the first opening section 52, which is sufficiently narrower than the cross-sectional area of the first mixed gas flow path section 51 (cross-sectional area by a surface perpendicular to the X-axis direction). Therefore, when a plurality of the first opening sections 52 are arranged in the first mixed gas flow path section 51, variation in the flow amount of the mixed gas G1 introduced from each of the first opening sections 52 is easily suppressed.

The inside diameter of the first opening section 52 is not particularly limited, but is desirably 0.1 mm or more and 100 mm or less, and more desirably 1 mm or more and 10 mm or less, from the viewpoint of optimizing the flow speed and the flow amount of the mixed gas G1 to be introduced.

The first opening section 52 may be an opening provided in the first mixed gas flow path section 51 as described above, or may have another shape. For example, it may be a tube extending from an opening.

The gas introduction units 5 arranged between the first separation membrane unit 21 and the second separation membrane unit 22 have the first opening sections 52 arranged on both the surface facing the first front surface 311 and the surface facing the second front surface 321.

The gas introduction pump 55 sends out the mixed gas G1 toward the first mixed gas flow path sections 51. The type of the gas introduction pump 55 is not particularly limited.

The gas introduction units 5 are arranged via a gap from the first front surface 311 of the first gas separation membrane 31. The distance d5 in the Z-axis direction between the gas introduction unit 5 and the first front surface 311 of the first gas separation membrane 31 is not particularly limited, but is desirably more than 0 mm and less than or equal to 30 mm, more desirably greater than or equal to 0.5 mm and less than or equal to 10 mm, and even more desirably greater than or equal to 1 mm and less than or equal to 5 mm. Thus, the mixed gas G1 introduced toward the first front surface 311 can spread to some extent along the first front surface 311, and can be suppressed from spreading too much. If the distance d5 is less than the lower limit value, the flow of the introduced mixed gas G1 may be impaired because the distance d5 is too small. In this case, it may become difficult to exhaust the introduced mixed gas G1 by the gas exhaust unit 6 described later. On the other hand, when the distance d5 exceeds the upper limit value, the distance d5 is too large, so that the introduced mixed gas G1 may be exhausted by the gas exhaust unit 6 before reaching the first front surface 311. In this case, the concentration of carbon dioxide on the first front surface 311 may decrease, and the separation efficiency may decrease.

The above description of the distance d5 also applies to the distance between the gas introduction unit 5 and the second front surface 321 of the second gas separation membrane 32.

Examples of the constituent material of the first mixed gas flow path section 51 include a resin material, a metal material, a ceramic material, and the like. It may also be a composite material containing these materials.

### 1.4. Gas Exhaust Unit

The gas exhaust unit 6 includes second mixed gas flow path sections 61, second opening sections 62 (gas exhaust section), and a gas exhaust pump 65.

The second mixed gas flow path sections 61 are arranged at positions adjacent to the first separation membrane unit 21 and the second separation membrane unit 22 in the Z-axis direction. Specifically, the gas exhaust units 6 are arranged below the first separation membrane unit 21, above the second separation membrane unit 22, and between the first separation membrane unit 21 and the second separation membrane unit 22.

As shown in FIG. 2, the second mixed gas flow path sections 61 have a prismatic shape elongated in the X-axis direction and have a hollow interior. In the second mixed gas flow path sections 61, a part of a surface facing the first front surface 311 of the first gas separation membrane 31 and the second front surface 321 of the second gas separation membrane 32 is open. These are the second opening sections 62, and the mixed gas G1 introduced toward the first front surface 311 and the second front surface 321 is taken into the second mixed gas flow path section 61 via the second opening sections 62. The second mixed gas flow path sections 61 are connected to the gas exhaust pump 65 via pipes. A mixed gas G1′ taken into the second mixed gas flow path sections 61 is exhausted by the gas exhaust pump 65 via pipes.

The gas exhaust unit 6 desirably includes a plurality of second opening sections 62. By this, the mixed gas G1′ can be exhausted over a wide range, and the separation efficiency can be easily increased.

In the second mixed gas flow path section 61 of the configuration as described above, the cross-sectional area of the second mixed gas flow path section 61 (cross-sectional area by a surface perpendicular to the X-axis direction) is sufficiently wide compared to the area of the second opening section 62, allowing for the mixed gas G1′ to be exhausted without delay through each second opening section 62.

The gas exhaust units 6 are arranged via a gap from the first front surface 311 of the first gas separation membrane 31. Since both the gas introduction units 5 and the gas exhaust units 6 are arranged, the introduction of the mixed gas G1 and the exhaust of the mixed gas G1′ can be performed quickly. Thus, the concentration of carbon dioxide CO₂ at the first front surface 311 and the second front surface 321 can be maintained high, and a decrease in the separation efficiency in the first gas separation membrane 31 and the second gas separation membrane 32 can be suppressed.

The inside diameter of the second opening section 62 is not particularly limited, but is desirably 0.1 mm or more and 100 mm or less, and more desirably 1 mm or more and 10 mm or less, from the viewpoint of optimizing the flow speed and the flow amount of the mixed gas G1′ to be exhausted. The inside diameter of the second opening section 62 is desirably larger than the inside diameter of the first opening section 52. By this, exhaust can be performed more smoothly.

The second opening section 62 may be an opening provided in the second mixed gas flow path section 61 as described above, or may have another shape. For example, it may be a tube extending from an opening.

The gas exhaust pump 65 exhausts the mixed gas G1′ taken into the second mixed gas flow path section 61. The type of the gas exhaust pump 65 is not particularly limited.

The gas exhaust units 6 are arranged via a gap from the first front surface 311 of the first gas separation membrane 31. The distance d6 in the Z-axis direction between the gas exhaust unit 6 and the first front surface 311 of the first gas separation membrane 31 is not particularly limited, but is desirably more than 0 mm and less than or equal to 30 mm, more desirably greater than or equal to 0.5 mm and less than or equal to 10 mm, and even more desirably greater than or equal to 1 mm and less than or equal to 5 mm. Thus, the mixed gas G1 introduced toward the first front surface 311 can spread to some extent along the first front surface 311, and can be suppressed from spreading too much. If the distance d6 is less than the lower limit value, the distance d6 is too small, so that the flow of the introduced mixed gas G1 may be impaired. In this case, it may be difficult to exhaust the introduced mixed gas G1 by the gas exhaust units 6. On the other hand, when the distance d6 exceeds the upper limit value, the distance d6 is too large, so that the introduced mixed gas G1 is exhausted by the gas exhaust unit 6 before reaching the first front surface 311, and the separation efficiency may be lowered.

The above description of the distance d6 also applies to the distance between the gas exhaust unit 6 and the second front surface 321 of the second gas separation membrane 32.

The distance d5 and the distance d6 described above may be the same as each other or may be different from each other. As an example of the latter, for example, the distance d6 is set to be larger than the distance d5. In this case, when the mixed gas G1 introduced from the gas introduction unit 5 is exhausted by the gas exhaust unit 6, a space can be secured around the second opening section 62, so that the exhaust efficiency can be further enhanced.

The gas separation device 1 shown in FIGS. 1 and 2 includes a plurality of gas introduction units 5 and a plurality of gas exhaust units 6. These are alternately arranged along the Y-axis direction (a direction parallel to the first front surface 311). Accordingly, since the gas introduction unit 5 and the gas exhaust unit 6 are adjacent to each other, the first opening section 52 (gas introduction section) and the second opening section 62 (gas exhaust section) are alternately arranged along the Y-axis direction. As a result, the gas exchange efficiency (introduction efficiency and exhaust efficiency) of the mixed gas G1 can be particularly enhanced. As a result, it is possible to particularly suppress a decrease in the separation efficiency of the first gas separation membrane 31 and the second gas separation membrane 32. Not all of the gas introduction unit 5 and the gas exhaust unit 6 need to be arranged alternately, and it is sufficient that at least some of them are arranged alternately.

The number of gas introduction units 5 included in the gas separation device 1 is not particularly limited, but is desirably plural. Thus, since a plurality of the first opening sections 52 (gas introduction sections) is provided, the mixed gas G1 can be uniformly introduced over a wide range, and the separation efficiency can be easily enhanced. As a result, it is possible to particularly suppress a decrease in the separation efficiency of the first gas separation membrane 31 and the second gas separation membrane 32.

The shortest distance between the center of the first opening section 52 and the center of the second opening section 62 on the X-Y plane is set according to the size of the gas separation device 1, the flow amount of the mixed gas G1, the inside diameters of the first opening section 52 and the second opening section 62, and the like, and is not particularly limited, but is desirably 1 mm or more and 300 mm or less, more desirably 5 mm or more and 200 mm or less, and even more desirably 15 mm or more and 100 mm or less. Thus, the mixed gas G1 can be uniformly introduced, so that the separation performance of the first gas separation membrane 31 and the second gas separation membrane 32 can be exhibited without waste.

Examples of the constituent material of the second mixed gas flow path section 61 include a resin material, a metal material, a ceramic material, and the like. It may also be a composite material containing these materials.

### 1.5. Exhaust Pump

Examples of the exhaust pump 7 include a screw pump, a dry pump such as a scroll pump, an oil rotary pump, and a turbo molecular pump, and the like. Of these, a dry pump is desirably used, and a screw pump is more desirably used. Since these do not use oil or liquid, there is no risk of contaminating the internal space S1 and internal space S2, and since they have low power consumption, they are useful as the exhaust pump 7.

### 2. Second Embodiment

Next, a gas separation device according to a second embodiment will be described.

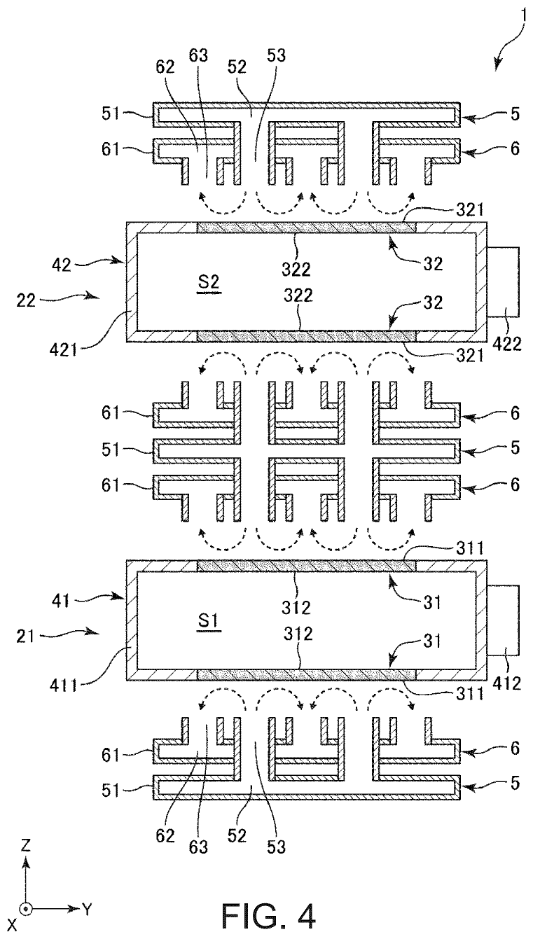

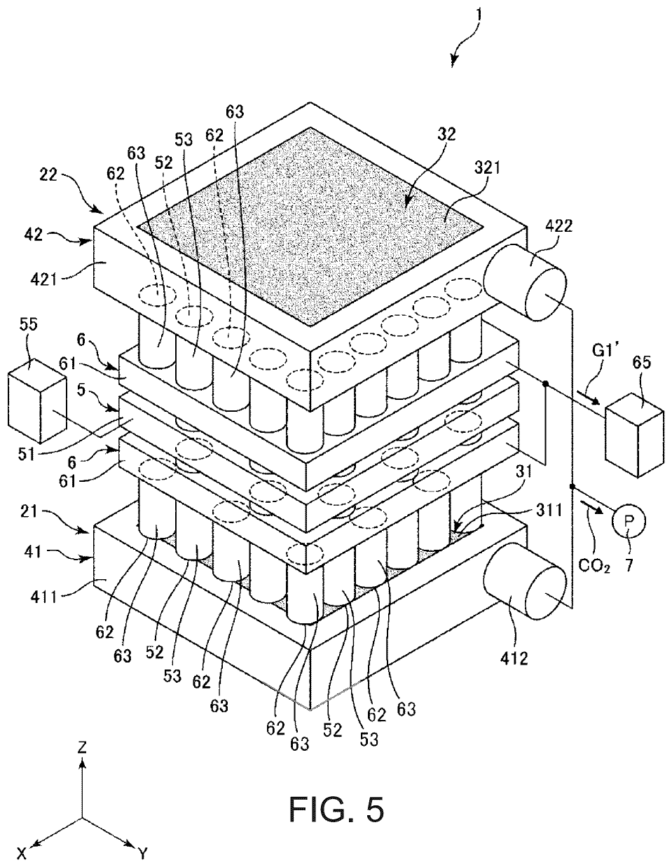

FIG. 4 is a cross-sectional view showing a configuration of the gas separation device 1 according to the second embodiment. FIG. 5 is a perspective view of the gas separation device 1 shown in FIG. 4. In FIG. 4, the illustration of the configuration that overlaps with the first embodiment is omitted. In FIG. 5, a part of the configuration shown in FIG. 4 is omitted.

Hereinafter, the second embodiment will be described, in the following description, mainly described differences from the first embodiment, the description of the same matters will be omitted.

The second embodiment is the same as the first embodiment except that the configurations of the gas introduction unit 5 and the gas exhaust unit 6 are different.

The gas introduction unit 5 shown in FIGS. 4 and 5 includes the first mixed gas flow path section 51, the first opening section 52, and an introduction pipe 53.

The first mixed gas flow path section 51 shown in FIGS. 4 and 5 is a box body that has a flat shape extending along the X-Y plane, is hollow, and has a substantially rectangular parallelepiped shape. The introduction pipe 53 is arranged such that a base end thereof is connected to the first mixed gas flow path section 51 so as to be aligned with the first opening section 52, and a tip end thereof is located in the vicinity of the first front surface 311 of the first gas separation membrane 31 and in the vicinity of the second front surface 321 of the second gas separation membrane 32. The distance between the introduction pipe 53 and the first front surface 311 and the distance between the introduction pipe 53 and the second front surface 321 are the same as the distance d5 described above. By providing such an introduction pipe 53, the mixed gas G1 can be guided to a position close to the first gas separation membrane 31 and the second gas separation membrane 32. As a result, the concentration of carbon dioxide on the first front surface 311 and the second front surface 321 is easily maintained to be high.

The gas exhaust unit 6 shown in FIGS. 4 and 5 includes the second mixed gas flow path section 61, the second opening section 62, and an exhaust pipe 63.

The second mixed gas flow path section 61 shown in FIGS. 4 and 5 is a box body that has a flat shape extending along the X-Y plane, is hollow, and has a substantially rectangular parallelepiped shape. The exhaust pipe 63 is arranged such that a base end thereof is connected to the second mixed gas flow path section 61 so as to be aligned with the second opening section 62, and a tip end thereof is located in the vicinity of the first front surface 311 of the first gas separation membrane 31 and in the vicinity of the second front surface 321 of the second gas separation membrane 32. The distance between the exhaust pipe 63 and the first front surface 311 and the distance between the exhaust pipe 63 and the second front surface 321 are the same as the distance d6 described above. By providing such an exhaust pipe 63, the mixed gas G1 introduced to the first front surface 311 and the second front surface 321 can be efficiently exhausted. As a result, the concentration of carbon dioxide on the first front surface 311 and the second front surface 321 is easily maintained to be high.

As shown in FIG. 5, the introduction pipes 53 and the exhaust pipes 63 are alternately arranged along the X-axis direction and the Y-axis direction (a direction parallel to the first front surface 311). As a result, the distance between the introduction pipe 53 and the exhaust pipe 63 can be made sufficiently close, and the distribution between them becomes more uniform. As a result, the gas exchange efficiency of the mixed gas G1 on the first front surface 311 and the second front surface 321 can be particularly enhanced. The arrangement of the introduction pipe 53 and the exhaust pipe 63 is not limited to this.

Also in the second embodiment as described above, the same effects as those of the first embodiment can be obtained.

### 3. Effects of Above-Described Embodiments

As described above, the gas separation device 1 according to the embodiment includes the first separation membrane unit 21, the gas introduction unit 5, and the gas exhaust unit 6. The first separation membrane unit 21 includes a first gas separation membrane 31 and a first gas flow path section 41. The first gas separation membrane 31 allows carbon dioxide CO₂ (predetermined gas component) contained in the mixed gas G1 supplied to the first front surface 311 to permeate through the first back surface 312 opposite to the first front surface 311, thereby separating the carbon dioxide CO₂. The separated carbon dioxide CO₂ flows through the first gas flow path section 41. The gas introduction unit 5 includes the first opening section 52 (gas introduction section). The first opening section 52 is arranged via a gap from the first front surface 311, and introduces the mixed gas G1 toward the first gas separation membrane 31. The gas exhaust unit 6 includes the second opening section 62 (gas exhaust section). The second opening section 62 is arranged via a gap from the first front surface 311, and exhausts the mixed gas G1 introduced from the gas introduction unit 5.

According to such a configuration, even if the concentration of carbon dioxide CO₂ at the first front surface 311 is reduced by the operation of the first gas separation membrane 31, the mixed gas G1 containing such a low concentration of carbon dioxide CO₂ can be quickly exhausted, and new mixed gas G1 can be quickly introduced. As a result, a gas separation device 1 is obtained in which the concentration of carbon dioxide CO₂ at the first front surface 311 is less likely to decrease, and the decrease in separation efficiency is suppressed.

In the gas separation device 1 according to the embodiment, the gas introduction unit 5 includes a plurality of the first opening sections 52 (gas introduction sections), and the gas exhaust unit 6 includes a plurality of the second opening sections 62 (gas exhaust sections).

According to such a configuration, the mixed gas G1 can be introduced uniformly over a wide range, and the mixed gas G1 can be exhausted over a wide range, so that the separation efficiency can be easily increased.

In the gas separation device 1 according to the embodiment, the first opening sections 52 (gas introduction sections) and the second opening sections 62 (gas exhaust sections) are alternately arranged along the Y-axis direction (a direction parallel to the first front surface 311).

According to such a configuration, the gas exchange efficiency (introduction efficiency and exhaust efficiency) of the mixed gas G1 can be particularly enhanced. As a result, it is possible to particularly suppress a decrease in the separation efficiency of the first gas separation membrane 31 and the second gas separation membrane 32.

The gas separation device 1 according to the embodiment includes a plurality of gas introduction units 5 and a plurality of gas exhaust units 6. The gas introduction units 5 and the gas exhaust units 6 are alternately arranged along the Y-axis direction (a direction parallel to the first front surface 311).

According to such a configuration, the gas exchange efficiency (introduction efficiency and exhaust efficiency) of the mixed gas G1 can be particularly enhanced. As a result, it is possible to particularly suppress a decrease in the separation efficiency of the first gas separation membrane 31 and the second gas separation membrane 32.

In the gas separation device 1 according to the embodiment, the gas introduction unit 5 includes the first mixed gas flow path section 51 through which the mixed gas G1 flows, and the first opening section 52 as a gas introduction section which opens to the first mixed gas flow path section 51.

According to such a configuration, since the mixed gas G1 is introduced from the first opening section 52, which is sufficiently narrower than the cross-sectional area (cross-sectional area by a surface perpendicular to the X-axis direction) of the first mixed gas flow path section 51, even in a case where a plurality of the first opening sections 52 are arranged in the first mixed gas flow path section 51, it is easy to suppress the variation in the flow amount of the mixed gas G1 introduced from each first opening section 52.

In the gas separation device 1 according to the embodiment, the gas introduction unit 5 further includes the introduction pipe 53 extending from the first opening section 52.

According to such a configuration, the mixed gas G1 can be guided to a position close to the first gas separation membrane 31. As a result, the concentration of carbon dioxide on the first front surface 311 can be maintained high.

In the gas separation device 1 according to the embodiment, the gas exhaust unit 6 includes the second mixed gas flow path section 61 through which the mixed gas G1 supplied from the gas introduction unit 5 flows, and the second opening section 62 as a gas exhaust section which opens to the second mixed gas flow path section 61.

According to such a configuration, as compared with the area of the second opening section 62, since the cross-sectional area of the second mixed gas flow path section 61 (cross-sectional area by a surface perpendicular to the X-axis direction) is sufficiently wide, the mixed gas G1 through each second opening section 62 can be exhausted without delay.

In the gas separation device 1 according to the embodiment, the gas exhaust unit 6 further includes the exhaust pipe 63 extending from the second opening section 62.

According to such a configuration, the mixed gas G1 introduced to the first front surface 311 can be efficiently exhausted. As a result, the concentration of carbon dioxide on the first front surface 311 can be maintained high.

The gas permeability of carbon dioxide of the first gas separation membrane 31 is desirably 5000 GPU or more and 100000 GPU or less.

According to such a configuration, it is possible to realize the first gas separation membrane 31 capable of reducing the input amount of energy required for separation, specifically, reducing the pressure difference between a first front surface 311 side and a first back surface 312 side.

The gas separation device 1 according to the embodiment further includes the second separation membrane unit 22. The second separation membrane unit 22 includes the second gas separation membrane 32 and the second gas flow path section 42. The second gas separation membrane 32 allows the carbon dioxide (predetermined gas component) contained in the mixed gas G1 supplied to the second front surface 321 to permeate through the second back surface 322 opposite to the second front surface 321, thereby separating the carbon dioxide. The second gas flow path section 42 is where the separated carbon dioxide flows through. The second separation membrane unit 22 is arranged on the opposite side of the first separation membrane unit 21 via the gas introduction unit 5 and the gas exhaust unit 6.

According to such a configuration, the gas separation device 1 with particularly high separation efficiency of carbon dioxide can be realized.

Although the gas separation device according to the present disclosure has been described with reference to the embodiments shown in the drawings, the present disclosure is not limited thereto.

For example, the gas separation device according to the present disclosure may be one in which each part of the above-described embodiment is replaced with an arbitrary component having the same function, or one in which an arbitrary component is added to the above-described embodiment.

What is claimed is:

1. A gas separation device comprising:
a first separation membrane unit including a first gas separation membrane configured to separate a predetermined gas component contained in a mixed gas supplied to a first front surface, by allowing the predetermined gas component to permeate through a first back surface, which is opposite to the first front surface, and a first gas flow path section through which the separated predetermined gas component flows;
a gas introduction unit that is arranged via a gap from the first front surface and that includes a gas introduction section that introduces the mixed gas toward the first gas separation membrane; and
a gas exhaust unit that is arranged via a gap from the first front surface and that includes a gas exhaust section that exhausts the mixed gas introduced from the gas introduction unit.

2. The gas separation device according to claim 1, wherein
the gas introduction unit includes a plurality of gas introduction sections and
the gas exhaust unit includes a plurality of gas exhaust sections.

3. The gas separation device according to claim 2, wherein
the gas introduction sections and the gas exhaust sections are alternately arranged along a direction parallel to the first front surface.

4. The gas separation device according to claim 1, wherein
a plurality of the gas introduction units and a plurality of the gas exhaust units are provided and
the gas introduction units and the gas exhaust units are alternately arranged along a direction parallel to the first front surface.

5. The gas separation device according to claim 1, wherein
the gas introduction unit includes a first mixed gas flow path section through which the mixed gas flows, and a first opening section as the gas introduction section that opens to the first mixed gas flow path section.

6. The gas separation device according to claim 5, wherein
the gas introduction unit further includes an introduction pipe extending from the first opening section.

7. The gas separation device according to claim 1, wherein
the gas exhaust unit includes a second mixed gas flow path section through which the mixed gas supplied from the gas introduction unit flows, and a second opening section as the gas exhaust section that opens to the second mixed gas flow path section.

8. The gas separation device according to claim 7, wherein
the gas exhaust unit further includes an exhaust pipe extending from the second opening section.

9. The gas separation device according to claim 1, wherein
gas permeability of carbon dioxide of the first gas separation membrane is 5000 GPU or more and 100000 GPU or less.

10. The gas separation device according to claim 1, further comprising:
a second separation membrane unit including a second gas separation membrane configured to separate the predetermined gas component contained in the mixed gas supplied to a second front surface, by allowing the predetermined gas component to permeate through a second back surface, which is opposite to the second front surface, and a second gas flow path section through which the separated predetermined gas component flows, wherein
the second separation membrane unit is arranged on an opposite side of the first separation membrane unit via the gas introduction unit and the gas exhaust unit.
